(19) United States
(12) Patent Application Publication
(10) Pub. No.: US 2026/0225401 A1
(43) Pub. Date: Aug. 6, 2026

(54) ROLLER UNIT FOR A VEHICLE, AND VEHICLE

(71) Applicant: SEW-EURODRIVE GMBH & CO. KG, Bruchsal (DE)

(72) Inventors: Friedrich MANZ, Kraichtal-Münzesheim (DE); Jan-Patrick KÖDDERITZSCH, Durmersheim (DE); Joshua Gordon David FRISCH, Hambrücken (DE); Bastian FREITAG, Brühl (DE)

(73) Assignee: SEW-EURODRIVE GMBH & CO. KG, Bruchsal (DE)

(21) Appl. No.: 19/152,156

(22) PCT Filed: Nov. 20, 2023
(86) PCT No.: PCT/EP2023/082348

§ 371 Date: Jul. 30, 2025

(30) Foreign Application Priority Data
Jan. 30, 2023 (DE) 10 2023 000 272.0

(51) Int. Cl. B60B 33/00; B60T 5/00

(52) U.S. Cl. CPC B60B 33/0092; B60T 5/00

(57) ABSTRACT

A roller unit for a vehicle includes a retaining member, at least one wheel rotatable relative to the retaining member about an axis of rotation, at least one brake unit for braking the at least one wheel and a ventilation device for manually ventilating the brake unit. The brake unit has a tie rod which is translationally displaceable, relative to the retaining member, between an upper end position, in which the brake unit is released, and a lower end position, in which the brake unit is actuated. The ventilation device has a lever including a first lever arm and a second lever arm, a lever fork, which is arranged on the second lever arm, and a locking device. The lever is swivelable relative to the retaining member about a lever axis, between a ventilation position and a working position. When the lever is in the ventilation position, the first lever arm of the lever retains the tie rod in the upper end position, when the lever is in the ventilation position, the lever fork is swivelable relative to the lever about a fork axis, between a free position and a retaining position, and, when the lever fork is in the retaining position, the lever fork is locked by the locking device such that the lever is retained in the ventilation position.

### FIELD OF THE INVENTION

The present invention relates to a roller unit for a vehicle, e.g., including a retaining member, at least one wheel rotatable relative to the retaining member about an axis of rotation, at least one brake unit for braking the at least one wheel and a ventilation device for manually ventilating the brake unit. The present invention also relates to a vehicle, e.g., an autonomous driving vehicle, which includes at least one roller unit as described herein.

### BACKGROUND INFORMATION

A roller bearing unit for a vehicle is described in German Patent Document No. 10 2016 013 570. The roller bearing unit has a drum brake that can be actuated via an electromagnet to brake a wheel. When the electromagnet is energized, the drum brake is released and the wheel can be turned. When the electromagnet is de-energized, the drum brake is actuated and the wheel is braked.

In the event of a power supply failure to the vehicle, the electromagnet is de-energized, the drum brake is actuated and the wheel is braked. This prevents uncontrolled movement of the vehicle. The drum brake can be ventilated manually and thus released via a ventilation device. This allows the vehicle to be pushed to a service station, for example.

A lockable castor for mobile devices is described in German Patent Document No. 80 22 219. The castor includes an axially displaceable adjusting bolt for locking and releasing a brake swing arm, which can be actuated by a locking lever. The locking lever is connected to a foot-actuated lever.

### SUMMARY

Example embodiments of the present invention provide a roller unit for a vehicle, and a vehicle, e.g., an autonomous driving vehicle.

According to example embodiments, a roller unit for a vehicle includes a retaining member, at least one wheel rotatable relative to the retaining member about an axis of rotation, at least one brake unit for braking the at least one wheel and a ventilation device for manually ventilating the brake unit. The brake unit has a tie rod which is translationally displaceable, relative to the retaining member, between an upper end position, in which the brake unit is released, and a lower end position, in which the brake unit is actuated. The ventilation device has a lever including a first lever arm and a second lever arm, a lever fork, which is arranged on the second lever arm, and a locking device. The lever is swivelable relative to the retaining member about a lever axis, between a ventilation position and a working position, in which, when the lever is in the ventilation position, the first lever arm of the lever retains the tie rod in the upper end position. When the lever is in the ventilation position, the lever fork is swivelable relative to the lever about a fork axis, between a free position and a retaining position. When the lever fork is in the retaining position, the lever fork is locked by the locking device such that the lever is retained in the ventilation position.

The brake unit of the roller unit can be ventilated manually and thus readily released. For this, the lever needs to be swiveled from the working position to the ventilation position and the lever fork swiveled from the free position to the retaining position. The lever fork is retained in the retaining position by the locking device, the lever is retained in the ventilation position, the tie rod is retained in the upper end position and the brake unit is released. In the event of a service incident, for example, if a power supply to the vehicle fails, the vehicle can be pushed to a service station. The ventilation device is relatively space-saving and inexpensive to implement.

According to example embodiments, the lever includes a lever block, on which the first lever arm is formed, and a lever plate, on which the second lever arm is formed. The lever plate is firmly connected, e. g., screwed, to the lever block. The two-part configuration of the lever allows the two parts, namely the lever block and the lever plate, to be arranged as parts that are readily produced. This further reduces production costs compared to a complex lever with a one-part configuration.

According to example embodiments, the lever axis extends through the lever block. For this, a bore is made in the lever block, through which bore a bolt passes, through which the lever axis extends. A separate fastening of the bolt is not necessary.

According to example embodiments, the ventilation device has a spring unit which acts on the lever in the direction of the working position. After swiveling the lever fork from the retaining position to the free position, the lever is automatically swiveled to the working position.

According to example embodiments, the spring unit is formed as a torsion spring, in which a winding axis of the torsion spring extends parallel offset to the lever axis, and in which the torsion spring bears against the second lever arm. The torsion spring also bears against the retaining member, for example. A torsion spring arranged in this manner is, for example, space-saving.

According to example embodiments, the lever fork has an upper leg and a lower leg, which embrace the second lever arm. This makes the connection between the lever fork and the lever mechanically, for example, stable.

According to example embodiments, the fork axis extends at a right angle to the lever axis. This makes the ventilation device, for example, space-saving.

According to example embodiments, the ventilation device has a base plate which is firmly connected, e.g., screwed, to the retaining member. The locking device is formed on the base plate in the form of a retaining arm, which engages over the lever fork which is in the retaining position. The base plate is readily produced and the production costs are low.

According to example embodiments, the brake unit has an electromagnet which, when energized, acts on the tie rod in the direction of the upper end position. The brake can be released by energizing the electromagnet.

According to example embodiments, the brake unit has a brake spring which acts on the tie rod in the direction of the lower end position. In the event of a power supply failure to the vehicle, the electromagnet is de-energized, the brake unit is actuated and the wheel is braked. This prevents uncontrolled movement of the vehicle.

According to example embodiments, the brake unit has an actuating unit coupled to the tie rod and a pair of brake shoes. When the tie rod is in the lower end position, the actuating unit swivels the brake shoes relative to the retaining member to generate a braking torque such that the brake shoes are in contact with a braking surface rotating with the wheel. Furthermore, when the tie rod is in the upper end position, the actuating unit swivels the brake shoes relative to the retaining member such that the brake shoes are out of contact with the braking surface. The brake unit is formed in the form of a drum brake.

According to example embodiments, the ventilation device includes a sensor for detecting a position of the lever. The sensor is formed as a microswitch or an optical sensor, for example. The sensor thus detects whether the lever is in the ventilation position or in the working position. The sensor transmits information about the position of the lever to a vehicle control unit via a signal line or a bus system.

According to example embodiments, a vehicle, e.g., an autonomous driving vehicle, includes a chassis and at least one roller unit as described herein. The roller unit is fastened to the chassis.

According to example embodiments, the roller unit is fastened to the chassis such that the retaining member is swivelable about a swivel axis relative to the chassis. This means that the at least one wheel can also swivel about the swivel axis relative to the chassis. The wheel is thus always aligned in the direction of travel. This makes it possible for the vehicle to negotiate bends.

Further features and aspects of example embodiments of the present invention are explained in more detail below with reference to the appended schematic Figures.

### BRIEF DESCRIPTION OF THE DRAWINGS

FIG. 1 is a top view of a ventilation device with the lever in the working position.

FIG. 2 is a cross-sectional view through the ventilation device along the section line A-A in FIG. 1.

FIG. 3 is a top view of a ventilation device with the lever in the ventilation position.

FIG. 4 is a cross-sectional view through the ventilation device along the section line B-B in FIG. 3.

### DETAILED DESCRIPTION

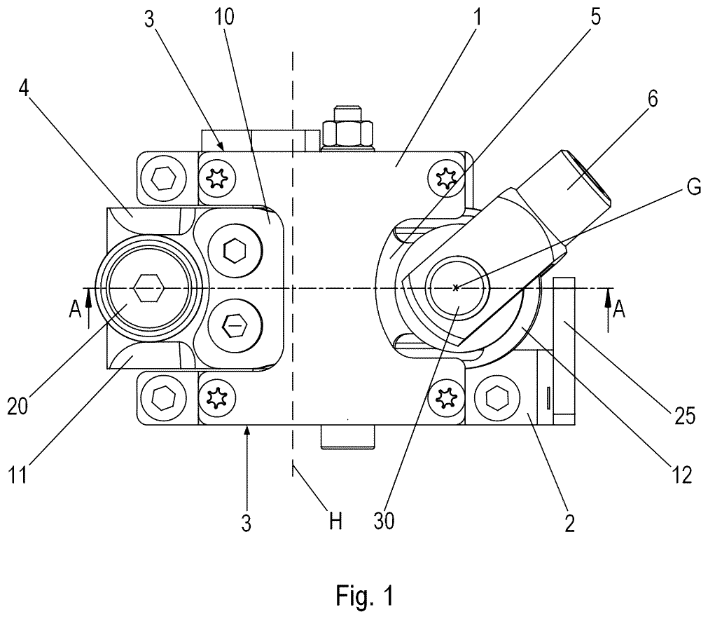

FIG. 1 is a top view of a ventilation device of a roller unit for a vehicle. The vehicle is used, for example, to transport objects in a technical system, e.g., in a paint system, or to deliver goods to a private recipient's home in a city or residential area. For example, the vehicle is an autonomous driving vehicle. The vehicle includes a chassis and multiple roller units, which are fastened to the chassis.

The roller unit includes a retaining member, a wheel and a brake unit for braking the wheel. The wheel can be rotated about an axis of rotation relative to the retaining member. The roller unit is fastened to the chassis such that the retaining member can be swiveled about a swivel axis relative to the chassis. This means that the wheel can also swivel around the swivel axis relative to the chassis. The axis of rotation extends at a right angle to the swivel axis. It is also possible that the roller unit has two or more wheels which are arranged parallel to each other. The wheels can then be rotated about a common axis of rotation and swiveled about a common swivel axis.

The brake unit has a tie rod 20. The tie rod 20 is in the form of a screw and has a shaft and a head. The tie rod 20 is translationally displaceable, relative to the retaining member, between an upper end position and a lower end position. In the upper end position of the tie rod 20, the brake unit is released and the wheel can be rotated. In the lower end position of the tie rod 20, the brake unit is actuated and the wheel is braked.

The brake unit has a brake spring. The brake spring acts on the tie rod 20 in the direction of the lower end position. The brake unit also has an electromagnet. When the electromagnet is energized, the electromagnet acts on the tie rod 20 in the direction of the upper end position. The electromagnet exerts a greater force on the tie rod 20 than the brake spring. When the electromagnet is not energized, the electromagnet does not act on the tie rod 20.

When the electromagnet is energized, the tie rod 20 is displaced to the upper end position by the electromagnet, the brake unit is released and the wheel can be rotated. If the electromagnet is not energized, the tie rod 20 is displaced by the brake spring to the lower end position, the brake unit is actuated and the wheel is braked.

The brake unit has an actuating unit coupled to the tie rod 20 and a pair of brake shoes. When the tie rod 20 is in the lower end position, the actuating unit swivels the brake shoes relative to the retaining member to generate a braking torque such that the brake shoes are in contact with a braking surface rotating with the wheel. When the tie rod 20 is in the upper end position, the actuating unit swivels the brake shoes relative to the retaining member so that the brake shoes are out of contact with the braking surface.

The roller unit also includes the ventilation device for manual ventilation of the brake unit. The ventilation device has a base plate 2. The base plate 2 is firmly connected, e.g. screwed, to the retaining member. The ventilation device also has two side blocks 3, which stand at a distance from each other on the base plate 2. The ventilation device also has a cover plate 1, which rests on the side blocks 3. The side blocks 3 are firmly connected, e.g., screwed, to the base plate 2 and the cover plate 1.

The ventilation device has a lever 10, which includes a first lever arm 11 and a second lever arm 12. The lever 10 is swivelable relative to the retaining member and relative to the base plate 2 about a lever axis H between a ventilation position and a working position. The first lever arm 11 and the second lever arm 12 are located on opposite sides with respect to the lever axis H. As illustrated, the lever 10 is in the working position.

The lever 10 includes a lever block 4, on which the first lever arm 11 is formed. At an end facing away from the lever axis H, the lever block 4 has two protrusions between which an opening is provided. The shaft of the tie rod 20 projects through this opening. The head of the tie rod 20 rests on the protrusions of the lever block 4.

The lever 10 includes a lever plate 5, on which the second lever arm 12 is formed. The lever plate 5 is firmly connected, e.g., screwed, to the lever block 4. The ventilation device has a lever fork 6. The lever fork 6 is arranged at an end of the lever plate 5 facing away from the lever axis H, and thus on the second lever arm 12. The lever fork 6 is swivelable relative to the lever plate 5, and thus to the lever 10, about a fork axis G. As illustrated, the lever fork 6 is in a free position.

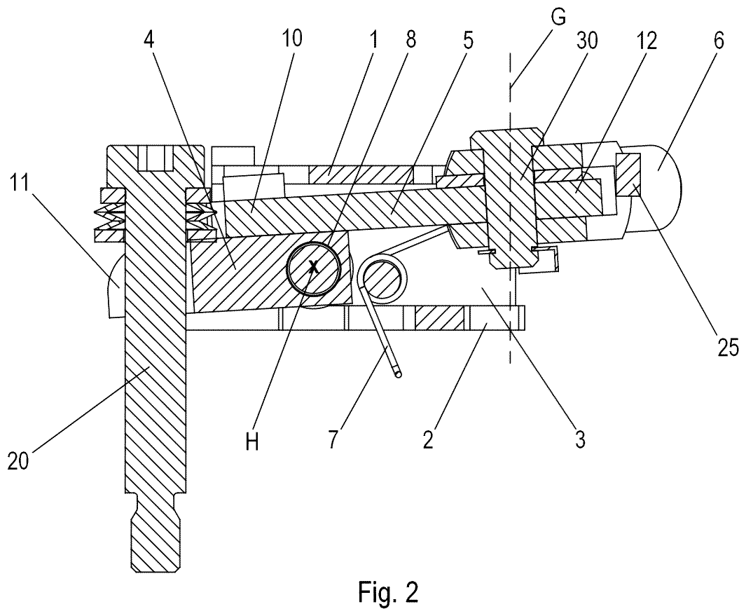

FIG. 2 is a cross-sectional view through the ventilation device along the section line A-A in FIG. 1. As mentioned above, the lever 10 is in the working position. The tie rod 20 is in the lower end position. The fork axis G extends at a right angle to the lever axis H.

The lever fork 6 has an upper leg and a lower leg. The upper leg and the lower leg embrace the lever plate 5 and thus the second lever arm 12. A pin 30 penetrates the legs of the lever fork 6 and the lever plate 5. The fork axis G extends through the pin 30 and through the lever plate 5.

A bolt 8 is mounted in the side blocks 3. The bolt 8 passes through a bore made in the lever block 4. The lever axis H extends through the bolt 8 and through the lever block 4.

The ventilation device has a spring unit 7. The spring unit 7 acts on the lever 10 in the direction of the working position. The spring unit 7 is formed as a torsion spring and is wound about a screw, which is mounted in the side blocks 3. A winding axis of the torsion spring extends parallel offset to the lever axis H. The torsion spring bears against the lever plate 5, and thus against the second lever arm 12. In addition, the torsion spring bears against the retaining member or alternatively against the base plate 2.

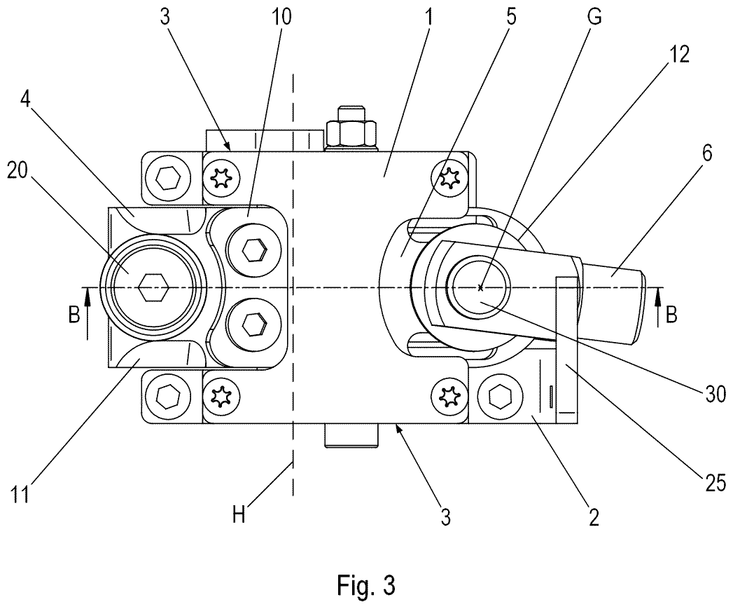

FIG. 3 is a top view of the ventilation device with the lever 10 in the ventilation position. Starting from the working position in which the lever 10 is located in FIG. 1 and FIG. 2, the lever fork 6 is moved towards the retaining member. This swivels the lever 10 about the lever axis H from the working position to the ventilation position.

When the lever 10 is in the ventilation position, the lever fork 6 is swivelable relative to the lever 10 about the fork axis G, between the free position, in which the lever fork 6 is located in FIG. 1 and FIG. 2, and a retaining position. As illustrated, the lever fork 6 is in the retaining position.

A locking device in the form of a retaining arm 25 is formed on the base plate 2. The retaining arm 25 engages over the lever fork 6, which is in the retaining position. When the lever fork 6 is in the retaining position, the lever fork 6 is locked by the locking device. This keeps the lever 10 in the ventilation position.

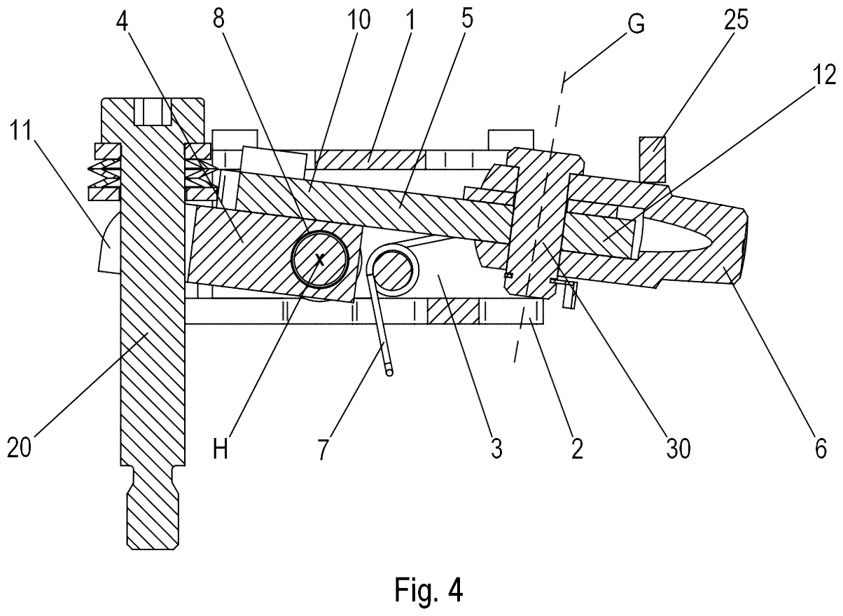

FIG. 4 is a cross-sectional view through the ventilation device along the section line B-B in FIG. 3. As mentioned above, the lever 10 is in the ventilation position. The tie rod 20 is in the upper end position. The lever block 4, and thus the first lever arm 11 of the lever 10, retains the tie rod 20 in the upper end position.

### LIST OF REFERENCE NUMERALS

1 Cover plate
2 Base plate
3 Side block
4 Lever block
5 Lever plate
6 Lever fork
7 Spring unit
8 Bolt
10 Lever
11 First lever arm
12 Second lever arm
20 Tie rods
25 Retaining arm
30 Pin
H Lever axis
G Fork axis

1-14. (canceled)

15. A roller unit for a vehicle, comprising:
a retaining member;
a wheel rotatable relative to the retaining member about an axis of rotation;
a brake unit adapted to brake the wheel, the brake unit including a tie rod that is translationally displaceable, relative to the retaining member, between an upper end position, in which the brake unit is released, and a lower end position, in which the brake unit is actuated; and
a ventilation device adapted to manually ventilate the brake unit and including a lever that includes a first lever arm, a second lever arm, a lever fork arranged on the second lever arm, and a locking device;
wherein the lever is swivelable relative to the retaining member about a lever axis, between a ventilation position and a working position;
wherein, in the ventilation position of the lever, the first lever arm of the lever retains the tie rod in the upper end position;
wherein, in the ventilation position of the lever, the lever fork is swivelable relative to the lever about a fork axis, between a free position and a retaining position;
wherein, in the retaining position of the lever fork, the lever fork is locked by the locking device to retain the lever in the ventilation position of the lever.

16. The roller unit according to claim 15, wherein the lever includes a lever block, on which the first lever arm is arranged, and a lever plate, on which the second lever arm is arranged, the lever plate being firmly connected and/or screwed to the lever block.

17. The roller unit according to claim 16, wherein the lever axis extends through the lever block.

18. The roller unit according to claim 15, wherein the ventilation device includes a spring unit adapted to act on the lever in a direction of the working position.

19. The roller unit according to claim 18, wherein the spring unit includes a torsion spring, a winding axis of the torsion spring extends parallel offset to the lever axis, and the torsion spring bears against the second lever arm.

20. The roller unit according to claim 15, wherein the lever fork includes an upper leg and a lower leg that embrace the second lever arm.

21. The roller unit according to claim 15, wherein the fork axis extends at a right angle to the lever axis.

22. The roller unit according to claim 15, wherein the ventilation device includes a main plate firmly connected and/or screwed to the retaining member, and the locking device is arranged on the main plate as a retaining arm that engages over the lever fork in the retaining position of the lever fork.

23. The roller unit according to claim 15, wherein the brake unit includes an electromagnet adapted to act on the tie rod, in an energized state, in a direction of the upper end position.

24. The roller unit according to claim 15, wherein the brake unit includes a brake spring adapted to act on the tie rod in a direction of the lower end position.

25. The roller unit according to claim 15, wherein the brake unit includes an actuating unit coupled to the tie rod and a pair of brake shoes, the actuating unit adapted to swivel the brake shoes, when the tie rod is in the lower end position, relative to the retaining member to generate a braking torque such that the brake shoes are in contact with a braking surface rotating with the wheel, and the actuating unit is adapted to swivel the brake shoes, when the tie rod is in the upper end position, relative to the retaining member such that the brake shoes are out of contact with the braking surface.

26. The roller unit according to claim 15, wherein the ventilation device includes a sensor adapted to detect a position of the lever.

27. A vehicle, comprising:
a chassis; and
at least one roller unit as recited in claim 15 fastened to the chassis.

28. The vehicle according to claim 27, wherein the vehicle is arranged as an autonomous driving vehicle.

29. The vehicle according to claim 27, wherein the roller unit is fastened to the chassis such that the retaining member is swivelable about a swivel axis relative to the chassis.

30. The vehicle according to claim 27, wherein the at least one roller unit includes a plurality of the roller units.

31. A roller unit for a vehicle, comprising:
a retaining member;
a wheel rotatable relative to the retaining member about an axis of rotation;
a brake unit adapted to brake the wheel, the brake unit including a tie rod that is translationally displaceable, relative to the retaining member, between an upper end position, in which the brake unit is released, and a lower end position, in which the brake unit is actuated; and
a release device adapted to manually release the brake unit and including a lever that includes a first lever arm, a second lever arm, a lever fork arranged on the second lever arm, and a locking device;
wherein the lever is swivelable relative to the retaining member about a lever axis, between a release position and a working position;
wherein, in the release position of the lever, the first lever arm of the lever retains the tie rod in the upper end position;
wherein, in the release position of the lever, the lever fork is swivelable relative to the lever about a fork axis, between a free position and a retaining position;
wherein, in the retaining position of the lever fork, the lever fork is locked by the locking device to retain the lever in the release position of the lever.

32. A vehicle, comprising:
a chassis; and
at least one roller unit as recited in claim 31 fastened to the chassis.
